(19) United States
(12) Patent Application Publication
(10) Pub. No.: US 2012/0023209 A1
(43) Pub. Date: Jan. 26, 2012

(54) METHOD AND APPARATUS FOR SCALABLE AUTOMATED CLUSTER CONTROL BASED ON SERVICE LEVEL OBJECTIVES TO SUPPORT APPLICATIONS REQUIRING CONTINUOUS AVAILABILITY

(76) Inventors: Robert Adam Fletcher, Dunblane (GB); Lyndon John Clarke, Edinburgh (GB); Patrick Terence Falls, Newbury (GB)

(21) Appl. No.: 12/840,288

(22) Filed: Jul. 20, 2010

(51) Int. Cl. G06F 15/173

(52) U.S. Cl. 709/223

(57) ABSTRACT

A computer-implemented method for managing the state of a multi-node cluster includes receiving an event indicative of a possible change in a current cluster state. A goal cluster state is identified if the current cluster state does not meet a service level objective. The goal cluster state includes a replication tree for replication among the member nodes of the goal cluster state. A transition plan for transitioning from the current cluster state to the goal cluster state is generated. The transition plan is executed to transition from the current cluster state to the goal cluster state.

### TECHNICAL FIELD

This invention relates to the field of computers. In particular, this invention is drawn to methods and apparatus for configuring a computer node cluster in accordance with service level objectives.

### BACKGROUND

The use of computers has become vital to the operation of many government, business, and military operations. Loss of computer availability can disrupt operations resulting in degraded services, loss of revenue, and even the possibility of human casualty.

For example, disruption of financial systems, electronic messaging, mobile communications, and Internet sales sites can result in loss of revenue. Disruption of an industrial process control system or health care system may result in loss of life in addition to loss of revenue.

Some applications can accommodate an occasional error or short delay but otherwise require high availability, continuous availability, or fault tolerance of a computer system. Most applications can accommodate variation in average response times, but when these become excessive over a long time period then this will directly impact the operational efficiency of an organization. Other applications, such as air traffic control and nuclear power plant control, may incur a high cost in terms of human casualties and property destruction when the computer systems are not available or sufficiently responsive to support the intended processing purpose.

The classifications of high availability, continuous availability and fault tolerance may be distinguished in terms of recovery point objective and recovery time objective. The recovery point objective is a measure of the amount of data loss that is considered acceptable. The recovery time objective is a measure of acceptable downtime for a computer system after a fault.

One approach for mitigating the risk of loss is to utilize a cluster of computer nodes. Multiple nodes are communicatively linked to appear as a single node to user applications. Clusters provide redundancy of data or computational resources for loss avoidance purposes.

Depending upon the loss to be averted, the cluster may be configured such that more than one node supports an executing application (i.e., load sharing with multiple active nodes).

Alternatively, nodes may be configured as passive nodes ready to take over in the event of the failure of an active node. In the absence of data sharing, data replication is necessary to meet various recovery point and recovery time objectives. For example, data is replicated from an active node to a passive node at the same location to support high availability. The passive node stands ready to assume the responsibilities of the active node in the event of an active node failure in an operation known as “failover”.

One disadvantage of prior art cluster architectures is that protection for failure of active nodes does not inherently ensure that additional service level objectives are met—particularly in the presence of continuous availability constraints and in an environment where the cluster composition may change.

### SUMMARY

Methods and apparatus for managing the state of multi-node clusters are described.

A computer-implemented method for managing the state of a multi-node cluster is disclosed. The method includes the step of determining a current cluster state. A goal cluster state is identified if the current cluster state does not meet a pre-determined service level objective. A transition plan for transitioning from the current cluster state to the goal cluster state is generated. The transition plan is executed to transition from the current cluster state to the goal cluster state.

A computer-implemented method for managing the state of a multi-node cluster includes receiving an event indicative of a possible change in a current cluster state. A goal cluster state is identified if the current cluster state does not meet a service level objective. The goal cluster state includes a replication tree for replication among the member nodes of the goal cluster state. A transition plan for transitioning from the current cluster state to the goal cluster state is generated. The transition plan is executed to transition from the current cluster state to the goal cluster state.

Other features and advantages of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a multi-node cluster.

FIG. 2 illustrates one embodiment of a two node cluster.

FIG. 3A illustrates one embodiment of response time service level objectives.

FIG. 3B illustrates one embodiment of recovery point objective service level objectives.

FIG. 3C illustrates one embodiment of recovery time objective service level objectives.

FIG. 4 illustrates a data flow diagram of a cluster control process.

FIG. 5 illustrates one embodiment of a cluster controller divided into functional blocks on a host node

FIG. 6 illustrates one embodiment of a process for implementing the analyzer block of FIG. 5.

FIG. 7 illustrates one embodiment of a process for implementing the director block and subsequent blocks of FIG. 5.

FIG. 8 illustrates one embodiment of a process of generating a replication tree.

FIG. 9 illustrates one embodiment of a replication tree.

FIG. 10 illustrates one embodiment of a current cluster partition including a replication tree.

FIG. 11 illustrates a step in one embodiment of a process of generating a replication tree.

FIG. 12 illustrates a step in one embodiment of a process of generating a replication tree.

FIG. 13 illustrates a step in one embodiment of a process of generating a replication tree.

FIG. 14 illustrates one embodiment of a portion of the transition planning process for generating actions to transition from a current cluster state to a goal cluster state.

FIG. 15 illustrates one embodiment of a portion of the transition planning process for generating actions to transition from a current cluster state to a goal cluster state.

FIG. 16 illustrates one embodiment of a portion of the transition planning process for generating actions to transition from a current cluster state to a goal cluster state.

FIG. 17 illustrates one embodiment of a portion of the transition planning process for generating actions to transition from a current cluster state to a goal cluster state.

FIG. 18 illustrates one embodiment of process for coordinating execution of a transition plan from a current cluster state to a goal cluster state.

### DETAILED DESCRIPTION

A cluster is a group of one or more computer nodes that act collectively to function as a single node. Typically any node of the cluster can be used to provide the function of any other node of the cluster in the event of hardware, software or network failures.

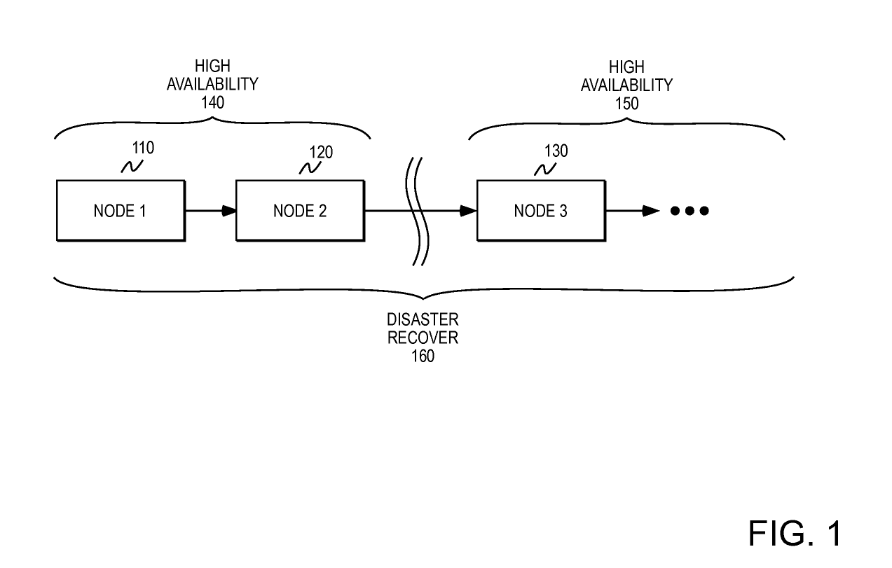

FIG. 1 illustrates one embodiment of a cluster including a plurality of nodes 110, 120, 130. In the illustrated embodiment, NODE 1 110 and NODE 2 120 form a high availability set 140. NODE 3 130 may likewise be paired with other nodes (not illustrated) to form a high availability set 150. NODE 1 is an active node. NODE 2 and NODE 3 are passive nodes. The cluster is configured such that high availability set 150 serves as a disaster recovery set for high availability set 140.

A “node” is a logical computer system or logical node. Physically, a logical node can be a real node or virtual node. A virtual node is a computer emulated by another computer. A real node is an actual computer. A client computer or a server computer in a client-server architecture can be real nodes, for example. A logical node may actually consist of a plurality of other nodes that are abstracted to appear as a single computer system. Thus, for example, a high availability set may itself be viewed as a node at a higher level of abstraction. A node that is not an abstraction of other nodes may be referred to as an “atomic node” or an “elemental node”. An elemental node may be either a physical computer or a virtual computer.

At a minimum, a high availability set requires two elemental nodes. When there are just two nodes, they are referred to as “primary” and “secondary”. When another node is provided for disaster recovery, the third node may be referred to as a tertiary node. Aside from the use of three nodes as an installation, the terms “primary”, “secondary”, and “tertiary” are not intended to limit generalization to any number of nodes.

Nodes of a high availability set typically reside at the same location or site and are communicatively coupled on a high speed local network to enable fast replication of data between the nodes. Replication of data locally is an integral part of achieving a desired recovery point objective (RPO) or recovery time objective (RTO) in the absence of shared storage. The RPO defines the maximum amount of data loss and the RTO defines the maximum downtime for the high availability system. Because the data can be replicated locally quickly, the recovery point objective can be kept short. In one embodiment, the recovery point objective is under a second. The time to detect node failure is also minimized because the round trip time required to verify that the node or application is no longer responding is short and hence the recovery time objective can also be minimized.

Due to the co-location of the primary and secondary nodes at the same site, a local copy of data residing with the secondary node is susceptible to loss from any catastrophic event that might disable the primary node. Examples of catastrophic events giving rise to potential destruction of local data includes: weather (e.g., hurricane), fire, explosion, etc. To protect against loss, data may be replicated to a different geographic location. Thus, for example, high availability set 150 may reside at a location that is geographically remote from the location of high availability set 140. High availability set 150 may then support disaster recovery protection for high availability set 140 in the event of a catastrophic event at the location of high availability set 140. The data being replicated may be compressed for transport in order to conserve network resources. However the compression increases the processing load on the machine performing the compression and so may indirectly impact the response time service level objectives if the compression is being performed on an active node.

Thus an application may have at least four service level objectives relating to availability including: a high availability recovery point objective (HA-RPO), high availability recovery time objective (HA-RTO), disaster recovery recovery point objective (DR-RPO), and disaster recovery recovery time objective (DR-RTO).

Nodes in a cluster are described as active or passive based on whether they are actively running the applications that the cluster supports. Passive nodes provide protection against hardware or software failure of the active nodes and also support maintaining application availability across planned downtime for hardware and software maintenance.

A cluster can use local and remote replication of data between nodes in the cluster to provide protection against loss of data. Various forms of replication may be used. For example, replication may be synchronous or asynchronous between any pair of nodes in the cluster.

Depending on the relative priorities of service level objectives not all nodes in a cluster need to replicate data between them. For example, a cluster might have two active nodes at one location which share the same data in a first shared disk storage system, and separate active and passive nodes at a second location which also share the data in a second shared storage location. Replication is only performed between the first and second shared storage location.

As distributed multi-node clusters have become more affordable in hardware and network costs, demand for higher service levels for availability and performance of clustered applications has increased. In particular, “continuous availability” from the perspective of the user is an example of one such level of service. A continuous availability system is a high availability system where the amount of data loss, as defined by RPO, and the amount of downtime, as defined by RTO, are such that end users consider that the system is continuously available even though a fault has occurred. Typically a continuous availability system has an RPO of under 5 seconds and an RTO of under 2 minutes. An RTO of less than 2 minutes means that end users will not give up trying to use the system before it becomes available again, and so will effectively be continuously available to them.

Accordingly, in one embodiment, service level objectives for HA-RPO and HA-RTO are selected to be below 5 seconds and 2 minutes respectively while DR-RTO and DR-RPO are selected to be below 10 seconds and 5 minutes respectively. Such values enable supporting continuous availability of applications to end users with minimal data loss and independently of failure mode. Continuous availability also requires that response time service levels, within any dependencies on throughput, must also be met otherwise end users will not consider the application continuously available.

Continuous availability is distinguished from fault tolerance which requires an RPO of zero (i.e., no data loss) and an RTO typically of less than 2 minutes. Continuous availability is a more relaxed constraint on the RPO and can typically utilize less expensive components because some level of data loss is acceptable.

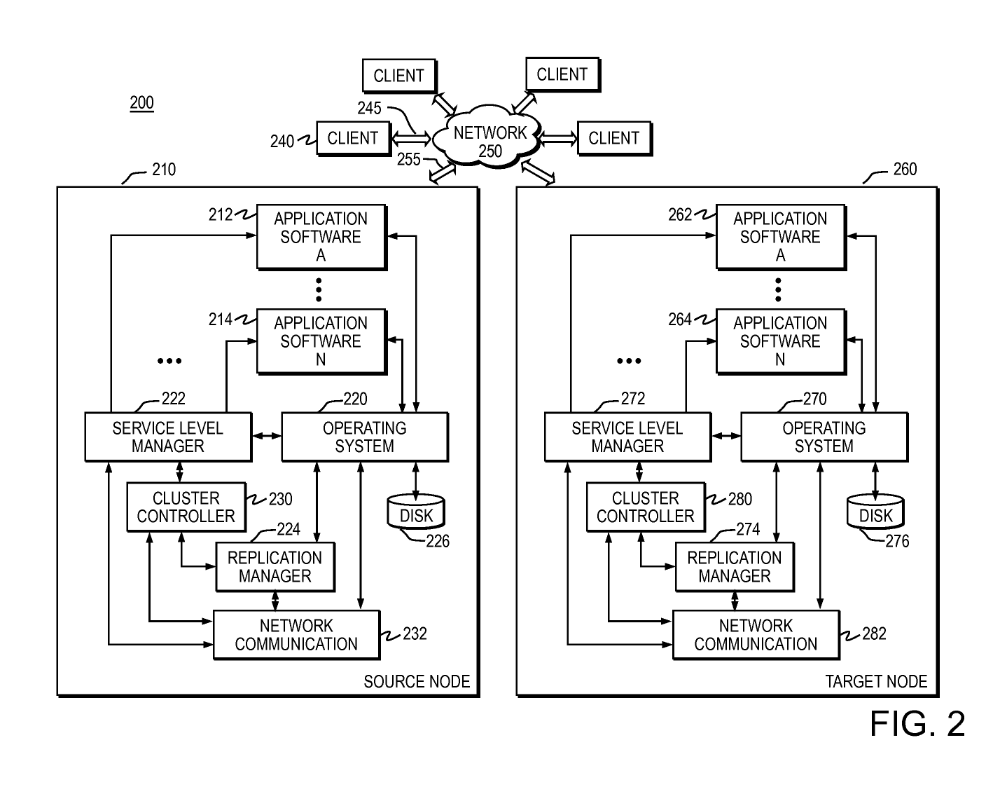

FIG. 2 illustrates one embodiment of apparatus 200 for replicating data from a source node to a target node within a cluster partition. The two illustrated nodes utilize replication of data from a first node (source node) to a second node (target node) to enable a desired level of data or application availability to the end user in the event of a failure associated with the source node.

The system comprises two nodes that show interactions of application software 212, 214, 262, 264, a service level manager block 222, 272, a cluster controller 230, 280, a replication manager 224, 274, a network communication block 232, 282, and disk 226, 276. Although the computer group may include two or more nodes that can be a mixture of multiple source and target nodes for providing a desired level of data or application availability to the end user, the system shown 200 is one of the simplest embodiments formed by two nodes. A first node is designated as the active or source node 210. A second node is designated as the protect node or target node 260. The first and second nodes are interconnected via at least one network in this case illustrated as 250 and 255.

If the source and target node are part of the same high availability set, they will typically be networked via a high speed local area network. If the source and target nodes are not part of the same high availability set, they may be networked via a wide area network. The clients 240 may be networked via any combination of local area and wide area network connections.

The service level manager blocks 222, 272 are elements of a system that provides protection for multiple applications 212, 214, 262, 264. In one embodiment the applications need only be run on one node, which would be called the “active node”. In this embodiment the protected applications are only run on the active node. If 210 is the active node, then in this embodiment the application software 262, 264 would not be present on the target node. In another embodiment the protected applications are run on one or more application nodes on the same local network as the source node. In this embodiment the application software uses a data protection block and network communication block on both the application nodes and the source node to communicate between the application nodes and the source node.

The data associated with an application that needs to be protected for continuous availability must be replicated. Application data that must be replicated includes all content from non-volatile storage on which the application depends. This includes file system data used to store files needed by the application, including files used to hold configuration data for the application (e.g., registry contents for a Microsoft Windows-brand operating system).

The nodes 210, 260 may have connections 255 to a network 250 for providing services to client computers 240 having connections 245 to the network 250. The network 250 may be a local area network or a wide area network, such as the Internet. Each of the two node computers 210, 260 may be connected to the network 250 via standard hardware and software interface connections 255.

The source node 210 is executing application software A-N (212-214). The source node is configured by the network communication block 232 to be visible via network connections 255 to application client computers 240. The service level manager block 222 on the source node 210 intercepts a subset of write operations to the disk 226 by the application software 212-214 using facilities provided by the operating system 220. In various embodiments, some or all of the source data is replicated to disk 276 on the target node. The specific data that is replicated is defined as the data used by the applications 212-214 that are designated as “protected applications”.

The cluster controller 230, 280 is responsible for managing the state of the cluster for the partition the node is part of. All nodes in a partition have a cluster controller, but management of the cluster is performed by a leader cluster controller node. The partition is the set of all nodes that can be seen or accessed by the leader cluster controller node. A change of state of the cluster may require a change of state of the leader. The service level manager blocks 232, 282 are used for defining and monitoring service level objectives for the applications running on the cluster. The service level manager will issue events when service level objectives are not met. The cluster controller will act on any events that might require a change to the cluster state.

An administrator issues administrator commands or management directives to the cluster controller via one of the client nodes 240. Such commands may change the cluster state selected by the cluster controller.

Service level manager block 222 monitors the state of the service level objectives and if they are not being met and to meet them requires a change to the cluster state then an event is raised by the service level manager that is handled by the cluster controller 230. The replication manager 224 of the source node forwards the data to the replication manager 274 of the target node for replication via the network communication blocks 232, 282 and the network 250.

Replication manager 224, 274 is responsible for ensuring replication of data in accordance with a replication tree generated by the leader cluster controller. Generally, the replication manager will ensure that its associated node is replicating from or to another node per its role as a source or target as set forth in the replication tree. The replication tree is a structure defining the replication roles of the nodes in the cluster partition.

The granularity of replication may vary depending upon the functional purpose of the high availability system. Replication may be application independent to provide for replication for all application and operating system data. In one embodiment, storage level replication granularity results in the replication of the full contents of a storage device. In another embodiment, file level replication granularity is provided to enable replication of a subset of the contents of a local storage device such as replication only of the data required for supporting continuous availability of pre-determined protected applications.

The network communication block 232 on source node 210 sends these write operations to the network communication block 282 on the target node 260 using the network 250, 255. Utilizing operating system 270 resources, the service level manager block 272 on the target node 260 executes write operations to the disk 276 on the target node 260 that are equivalent to the operations that occurred on the source node 210. The service level manager blocks 222, 272 define the data that needs to be protected.

The service level manager blocks may also handle compression on the source node and decompression on the target node to facilitate more efficient utilization of network resources. When the source and target nodes are part of a high availability set, compression and decompression will likely not be used because the source and target nodes will be in close proximity and will be coupled to each other via a high speed local area network 250.

Source node 210 may be alternatively be a passive node of a high availability set that is replicating data to a target node 260 of a disaster recovery set. In such a case, network 250 is likely a wide area network. Compression and decompression may be utilized to enhance network throughput in an effort to overcome bandwidth limitations otherwise imposed by the wide area network.

The application specific protection blocks are inapplicable while the source node is acting as a passive node to a high availability set. In such a case, the passive node is itself a target node being provided with data for replication from an active source node of the high availability set. The passive node then only need forward the same data for replication by a target node of a disaster recovery set, for example.

Although prior art clusters support total failovers in the event of a failure of an active node, prior art cluster management systems do not adequately address other impairments of the active node or events that cause or are likely to cause the cluster to fail to meet other service level objectives.

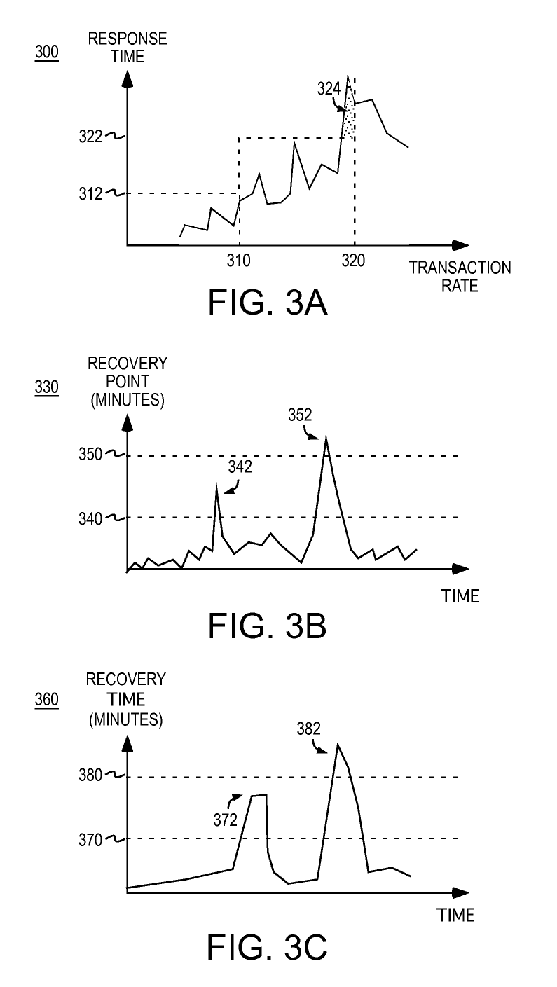

FIG. 3A illustrates one embodiment of service level objective (SLO) defined in terms of response time given specific transaction rate thresholds. Chart 300 illustrates response time versus transaction rate. The SLO requires response times less than a first threshold 312 for transaction rates less than a first rate 310. The SLO permits slower response times for higher transaction rates as long as the response time is less than a second threshold 322 for transaction rates between the first rate 310 and a second rate 320. The shaded portion 324 of the performance graph indicates a failure to meet the service level objective.

FIG. 3B illustrates one embodiment of a service level objective defined as a recovery point objective. Chart 330 illustrates the amount of data that is estimated would be lost in the event of a failure at a particular point in time. The amount of data lost is measured in terms of time (minutes). Threshold 340 may be a trigger threshold indicative that action should be taken to avoid failing to meet a recovery point objective established by threshold 350. At time 342, the recovery point is estimated to exceed the warning threshold (340). At time 352, the estimated time exceeded the recovery point objective limit that reflects a failure to meet the RPO.

FIG. 3C illustrates one embodiment of a service level objective defined as a recovery time objective. Chart 360 illustrates the amount of time that is estimated to be required (at different points in time) to make an application available to a user again. The length of time is measured in minutes. Threshold 370 may be a trigger threshold indicative that action should be taken to avoid failing to meet a recovery time objective established by threshold 380. At time 372, the recovery time is estimated to exceed the warning threshold (370). At time 382, the estimated time exceeded the recovery time objective limit that reflects a failure to meet the RTO.

Service level objectives may be defined in terms of transaction rates, response times, time of day, recovery time objectives, recovery point objectives, wide-area network (WAN) utilization cost, statistical values describing the performance of the node, hardware utilization cost and software utilization cost and generally any variable describing application availability, functionality and performance. A cluster controller may reconfigure the cluster as appropriate in order to meet one or more SLOs or to minimize the departure from SLOs. When a failure to meet an SLO occurs or is anticipated, for example, the cluster controller may add nodes, drop nodes, change active nodes, add active nodes, failover, change replication tree, etc. to change the state of the cluster in order to bring service in line with SLOs.

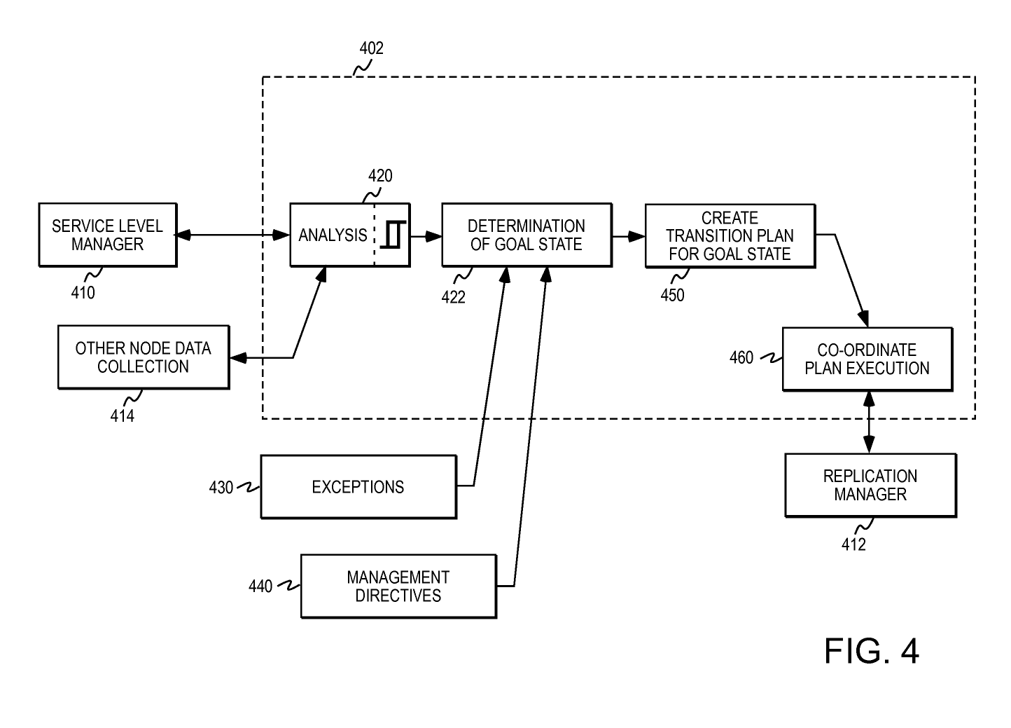

In order to decide whether a cluster state change is necessary as a result of some event, an analysis must be performed on the cluster to determine the value of all attributes used to define SLOs. FIG. 4 illustrates a data flow diagram of a cluster control process 402.

The service level objectives identify attributes whose values must be determined to gauge compliance. Accordingly the Service Level Manager 410 communicates with analysis block 420 and provides an indication of the data that needs to be collected. This data is provided to analysis block 420 from data collection processes such as other node data collection 414. This collected data is made available for analysis block 420.

The result of the analysis is a current cluster state identifying the member nodes of sets for a given hierarchical level, which nodes are active versus passive, the replication tree, etc. The status of the network between nodes is likewise tracked.

The current cluster state is provided to block 422 for determining a goal cluster state. In addition, exception events 430 and management directives 440 are provided as inputs to block 422. An exception event might reflect that a specific node has failed or has been removed from a set. A management directive might be a command to change the active node or to add or remove nodes from a set. The result is a goal cluster state. The goal cluster state includes the replication tree for the cluster.

Transition planning 450 is used to develop a plan for transitioning from the current cluster state to the goal cluster state. Block 460 coordinates execution of the transition plan by sending actions to the replication managers 412 on the local or remote nodes to effectuate the transition to the goal cluster state.

In one embodiment, the analysis block 420 incorporates a hysteretic filter ( [symbol] ) with respect to information communicated from block 420 to block 422. The hysteretic filter serves to suppress communications until a certain amount of time has elapsed. In various embodiments, the hysteretic filter may target pre-determined types of events for suppression. The suppression prevents multiple triggers of block 422 in short succession due to partially executed transitions or simply a cascade of notifications relating to a single event. The hysteretic filter gives the system time to settle after changes to the cluster state. Otherwise, for example, block 422 might continue to generate new goal cluster states before a transition to a previously determined goal cluster state is complete.

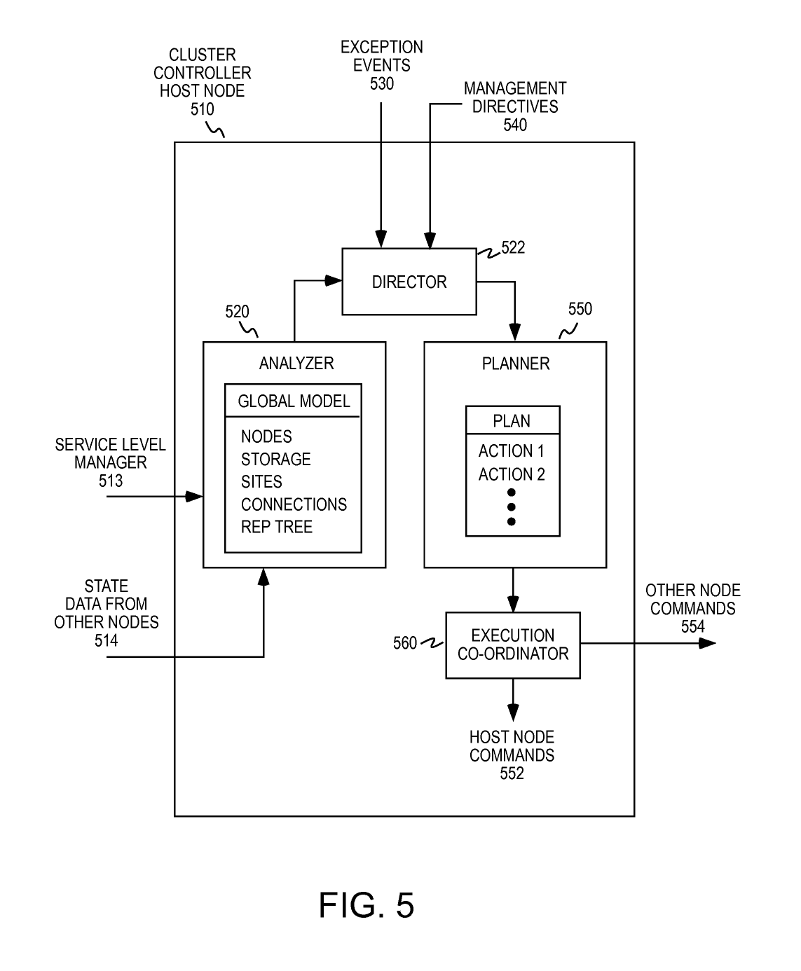

FIG. 5 illustrates one embodiment of a cluster controller divided into functional blocks on a host node. Each node of the cluster has a cluster controller. One cluster controller is selected as the “leader”. The other cluster controllers facilitate the provision of information to the leader and the execution of administrative tasks issued by the leader. One of the non-leader cluster controllers may take the place of the leader in the event of a failure of the leader. In one embodiment, the cluster controllers determine a leader among themselves by utilizing a numerical node identifier assigned to every node. The use of the numerical node identifier allows each cluster controller to independently arrive at the same result for the leader. In one embodiment, the leader is determined as the cluster controller associated with the lowest numbered node identifier.

The analyzer block 520 collects information from the replication manager 512, service level manager 513 and other nodes 514 to maintain a global model of the cluster including the node status, storage, location, connections, and replication tree information. Node performance data and other data collected are used for determining compliance with one or more SLOs.

The analyzer informs the director block 530 if there is a potential need to change the state of the cluster. The analyzer, for example, will issue events to identify nodes that have joined the cluster and to identify nodes that have left the cluster.

The management directive block 540 is an interface through which administrators may dictate changes via commands to the cluster. Such commands include adding an active node, removing an active node, replacing an active node with another node as active, stopping an active node from continuing as an active node, enabling replication, stopping replication, shutdown of specified nodes, and replication bounce. Replication bounce is a command to halt and then restart replication. The replacement of an active node requires that the active node and its replacement be synchronized.

The director block 522 receives the current cluster state information and any exception events 530 and management directives 540 regarding the cluster. The director outputs a goal cluster state including goal replication tree for the cluster to planner 550. Planner 550 generates a plan of actions to be performed in a particular order for transitioning from the current cluster state to the goal cluster state. The plan is communicated to execution coordinator block 560. The execution coordinator block 560 then coordinates execution of the planned actions as necessary with the local or other nodes to effectuate the transition to the goal cluster state.

In various embodiments, the analyzer and director are separate continuously running processes. Thus the analyzer monitors the cluster and informs the director regarding state changes to the cluster. The director waits to receive notification of events and then acts upon such notifications.

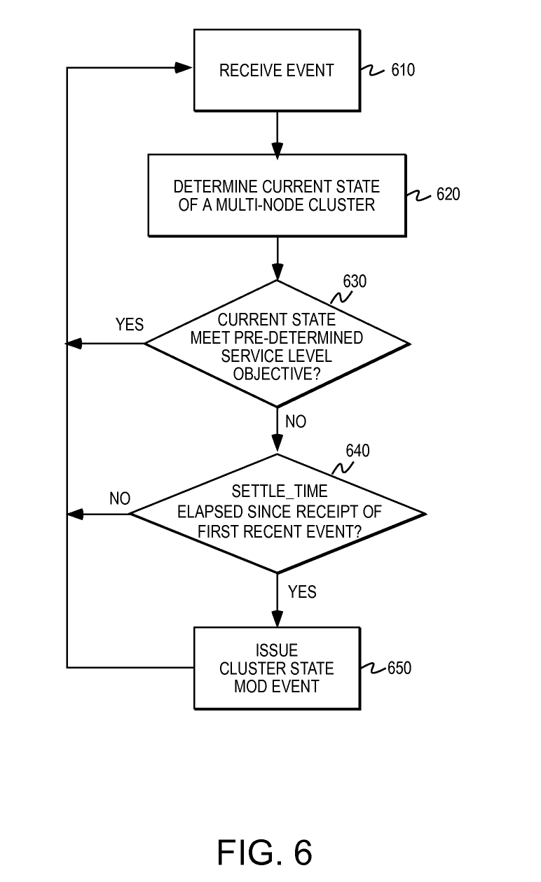

FIG. 6 illustrates one embodiment of an analyzer block. In particular, steps 610-650 illustrate a high-level view of a cluster status analyzer. The analyzer collects events received from network communications and the service level manager in step 610. In step 620, a current cluster state is determined including the node status, storage, location, connectivity, and replication tree. Step 630 determines whether the current cluster state meets the service level objectives. If so then processing continues with step 640.

If the current cluster state does not meet a service level objective, then a cluster state modification event should be issued. However, the method of FIG. 6 includes hysteresis. Once an event is submitted, issuance of events is suppressed until a pre-determined period of time (“SETTLE_TIME”) has elapsed as determined by step 630. In one embodiment, the elapsed time is measured from the first event that occurred after the last cluster state mod event issued by the analyzer, or if no such previous mod event then from the first event since the cluster controller was last started on this node. If the settle time has lapsed, then a cluster state modification event is issued in step 650 and processing continues with step 610. Otherwise processing continues with step 610.

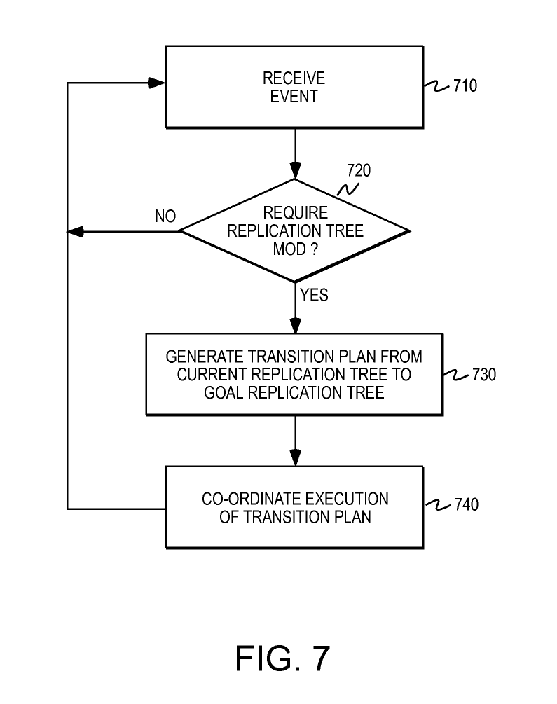

FIG. 7 illustrates one embodiment of the director block of FIG. 5. In step 710, an event is received. Step 720 determines whether the event requires a modification of the replication tree. If no modification is required, then processing continues with 710. If a modification to the current replication tree is required, then a transition plan is generated in step 730. The transition plan consists of the steps required to transition from the current replication tree to a goal replication tree determined from the event. Execution of the transition plan is coordinated in step 740 as appropriate among the nodes.

The types of events that the director may be notified of include adding a node, removing a node, replacing an active node with another node as active, stopping an active node from continuing as an active node, enabling replication, stopping replication, shutdown of specified nodes, and replication bounce. Director determines from the event whether a change in the replication tree is necessary. A replace active command, for example, would change the head of a replication tree. Similarly adding a node as an active node will result in modification of a replication tree. Removal of a node that is currently a member of a replication tree will likewise require a change in the replication tree. In the event that a change in the replication tree is necessary, director generates a new replication tree as part of the goal cluster state.

A nomenclature for describing replication trees is useful for discussing the process of changing states and replication trees. The nodes participating in replication form a replication tree. For any hierarchical level, each link of the replication tree requires at least two nodes (source node and target node). A source node for a successor target node may itself be the target node of a predecessor source node in the replication tree. Referring to FIG. 1, for example, the NODE 1 is a source node for NODE 2 (i.e., target node). NODE 2 serves as a source node for a successor target node in the replication tree such as NODE 3.

A generic nomenclature for identifying a replication tree is defined as follows. Elements within curly braces “{ }” represent an unordered set of nodes. Elements within square brackets “[ ]” represent a replication tree-ordered set of nodes. The order of the elements within the “[ ]” indicates the order of replication within that set. The location or site may be expressly indicated when appropriate with a capital letter subscript. Thus for example, “1_{A}” indicates that node 1 is at location A. “{123}_{A}” indicates node 1, 2, and 3 are at location A. “[213]_{A}” indicates that the set of nodes 1, 2, 3, is at location A and that the replication order is 2→1→3. The subscript may be omitted for brevity except for cases in which the location is pertinent to avoid confusion as to identity of nodes or operation performed.

For purposes of example and brevity, nodes are indicated with single digit numerical symbols. However, a cluster is not inherently limited to 10 or fewer nodes. Thus in the event of multi-symbol node identifiers, the nomenclature incorporates separators such as commas or other delimiters to distinguish the individual nodes as needed (e.g., “[23, 2, 15]_{A}”. The illustrated examples utilize single digit node identifiers without the use of delimiters for brevity.

An asterisk “*” is used to identify an active node. Thus “[1*23]_{A}” indicates that a set with 3 members (nodes 1, 2, 3) at location A; the replication order is from 1→2→3; and “1” is the active node while nodes 2 and 3 are passive.

If bracketed sets appear adjacent to each other, then the first set is a source set and the second set is a target set for replication. On a macro level, the replication tree is extending or branching from the source set to the target set. On a micro level, the branch may come from any node in the first set. The first node of the second set is not necessarily daisy-chained for replication from the last node of the replication tree handling the first set. If the first and second sets are located at different sites, then they may form a disaster recovery set pair. Thus “[1*]_{A}[2]_{B}” indicates two distinct sets in a replication tree. Any set may be abstracted as a node from the viewpoint of higher hierarchical levels of a cluster.

With knowledge of the cluster global model and events giving rise to a need to modify the replication tree, the director can determine a goal cluster state. A replication tree must be generated for the goal cluster state.

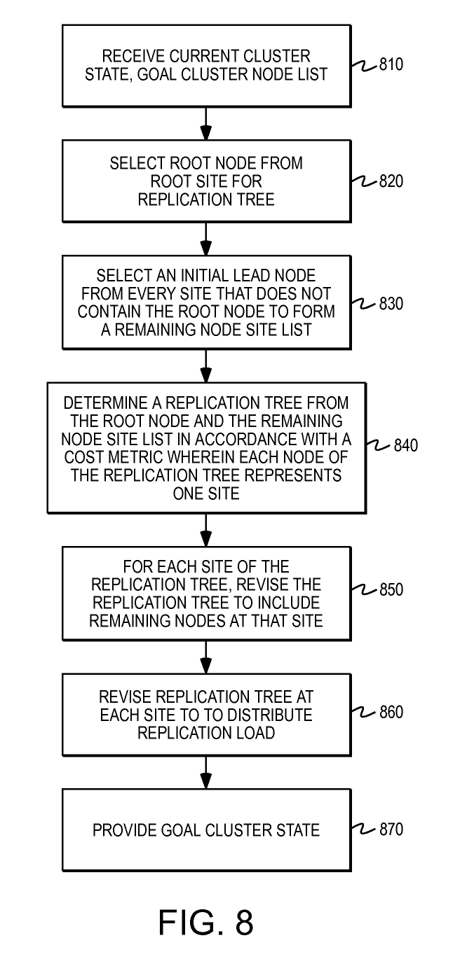

FIG. 8 illustrates a generalized process for generating a replication tree. The cluster includes a plurality of nodes distributed across one or more sites. Each site may have one or more nodes. Each site may have passive nodes, active nodes, or a mix of passive and active nodes. Beginning with step 810, a current cluster state and a goal cluster node list are received. The goal cluster node list includes the accompanying node status as active or passive and replication enable or disabled. The goal cluster node list identifies a cluster goal partition. The goal partition may or may not be the same as the current partition (i.e., the goal and current partitions may have a set of nodes that is not identical).

In step 820, a root node for a root site is selected for the replication tree. The ranking of sites or locations is an administrator decision. Typically one site will represent a production site and thus be of higher rank than a disaster recovery site, for example. Sites other than the production site may have varying ranks or may be of the same rank. The root node is the highest ranked node on the highest ranked site with an active node. The ranking of nodes may likewise be an administrator decision. The nodes may be ranked, for example, by performance specifications if the nodes have different performance specifications.

An initial lead node is identified for every site that does not contain the root node to form a remaining node site list in step 830. Typically, the initial lead node for each site is the highest ranked active node. If there is no active node, then the initial lead node for a given site is the highest ranked passive node. In one embodiment, ranking of sites and nodes within sites is determined by the administrator.

In step 840, a replication tree is determined from the root node and the remaining node site list in accordance with a cost metric. At this point, each node in the replication tree represents one site.

In step 850, for each site of the replication tree, the replication tree is revised to include remaining nodes at that site. In step 860, the replication tree is revised at each site to distribute the replication load.

The goal cluster state is provided in step 870. The goal cluster state includes the goal replication tree. The goal cluster state includes all nodes in the cluster irrespective of whether they are part of the goal replication tree. The node attributes (i.e., active, passive, availability for replication, etc.) are also identified in the goal cluster state.

With respect to step 840, various cost functions may be utilized to determine the initial replication tree. For example, beginning with the root node, a replication tree may be derived by computing a cost of every variant of the replication tree made from the remaining node site list. The tree with the lowest cost or at least a cost not greater than any other variant is selected.

In one embodiment, the cost metric is a “WAN weight”. The total WAN weight is the sum of all WAN weights between consecutive source and target nodes in the replication tree where the source and target are on different sites. At this stage, the WAN weight is the cost of communicating between sites. In one embodiment, this cost may be defined in terms of network hops. In other embodiments, more sophisticated cost functions relating to an economic cost of transmitting data between the sites may be used. In one embodiment wherever independent replication is performed between nodes, the WAN weight between nodes sharing the same independently replicated data is deemed to be zero. Independent replication is replication that uses a mechanism other than the replication manager for replicating the data.

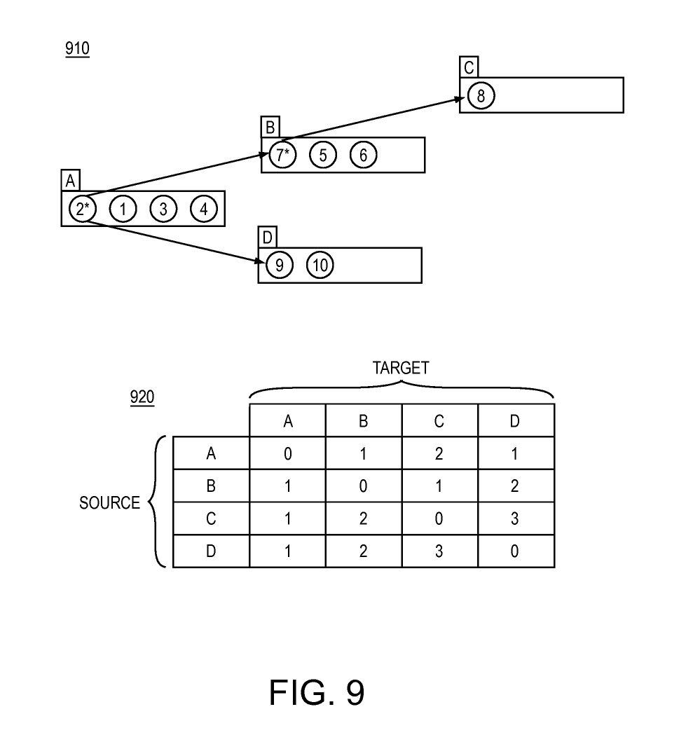

FIG. 9 illustrates one embodiment of a replication tree 910 as it might be determined by step 840 from a WAN weight table 912. In this case, there are four sites: A, B, C, D. The highest ranking active node, or highest ranking passive node if no active nodes, at each site was selected to form the remaining node site list. The replication tree connects each node of the remaining node site list to root node 1. Replication tree 910 includes nodes 1, 7, 8, and 9. The other nodes are the remaining nodes at each site and are not part of the replication tree at this point.

Each connected node in this tree is associated with a distinct site. The WAN weight between any two sites is the same irrespective of the source and target nodes, thus table 920 reflects only the WAN weight between any two sites.

A “minimum” cost may be determined by exhaustively exploring every possible replication tree. For each new instance of a replication tree, if the WAN weight is less than the WAN weight of a best candidate replication tree, then the new instance replaces and becomes the candidate replication tree.

In the event of a tie, a tie-breaker cost function is used to determine the best candidate replication tree as between the existing best candidate and the new instance. In one embodiment, the tie-breaker cost function is based upon a “total active weight” function defined as follows:

$$TAW = {\sum }_{i = First Site}^{Last Site} {AW}_{i} , wherein$$

$${AW}_{i} = \frac{COUNT ( TARGET SITES )}{MIN ( COUNT ( TARGET SITES ) , COUNT ( ACTIVE {NODES}_{i} ) )} ,$$

if site i has at least one active node and AWᵢ=0 otherwise.

AWᵢ is the Active Weight at site “i”. “TARGET SITES” includes every site in the partition having an active node except the root site. “ACTIVE NODES” includes all active nodes at site i. The total active weight is computed as a sum of the AWᵢ. The active weights are computed only for sites having an active node.

If the total active weight still results in a tie, another tie-breaker may be used. In one embodiment the tie-breaker cost function is based upon a “total passive weight” function defined as follows:

$$TPW = {\sum }_{i = First Site}^{Last Site} {PW}_{i} , wherein$$

$${PW}_{i} = \frac{COUNT ( TARGET SITES )}{MIN ( \begin{matrix}COUNT ( TARGET SITES ) , \\ COUNT ( PASSIVE {NODES}_{i} )\end{matrix} )} ,$$

if site i has at least one passive node and PWᵢ=0 otherwise.

If there is still no distinction between the existing best candidate and this instance of a new replication tree, then either may be selected as the candidate replication tree.

With respect to step 860, the replication from one site to another is an “inter-site” replication with one site serving as the source site and another as the target site. The inter-site replication tree branches are revised to select the source node within the source site as appropriate in accordance with balancing the WAN replication load from the source site to the target site. The load balancing aims to minimize the processing required on each source node to perform WAN replication from that node. In one embodiment, active nodes are excluded from WAN replication when passive nodes are available at the same site to serve as the source nodes for inter-site replication from that site. If there is more than one node on a site then the source side of the replication branch on a source site are distributed or moved to other nodes on the same site in a round robin fashion starting at the last node on the site (i.e., the last node of the intra-site replication chain) and using only passive nodes where possible.

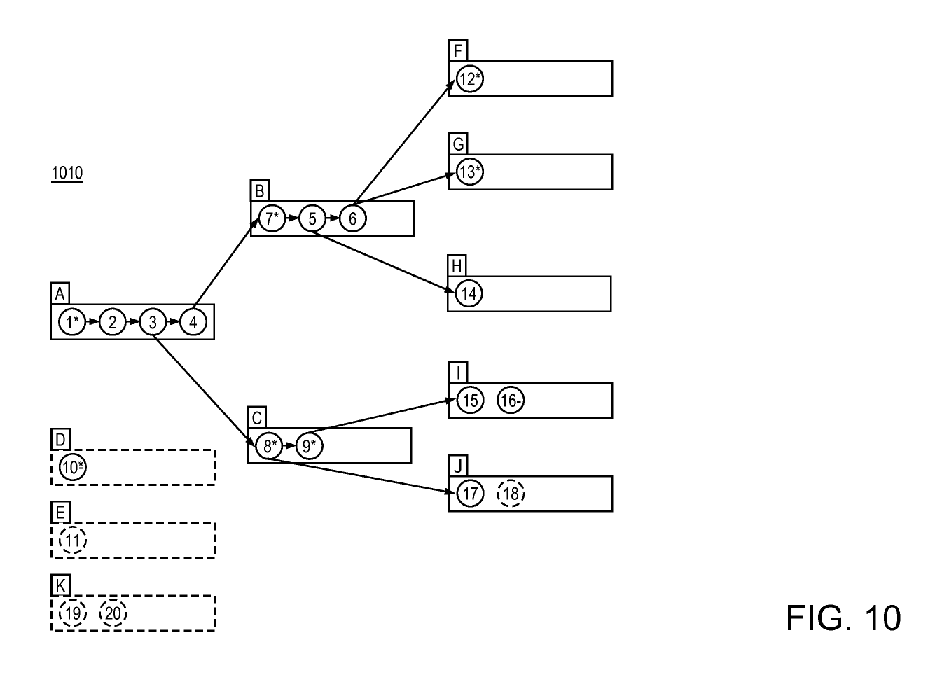

FIG. 10 illustrates one embodiment of a current cluster 1010 including sites, active nodes, replication tree, etc. Nodes 11, 18, 19 and 20 cannot be seen on the network by the remaining nodes and are therefore not part of the partition. Nodes 10 and 16 are part of the partition but do not have replication enabled, as indicated by the minus sign, and are therefore not part of the replication tree. Sites D, E, and K are part of the cluster but are not part of the replication tree because either their associated nodes are not enabled for replication or are not visible to the other nodes in the partition. A dotted or broken line for a node indicates that the node is not visible to the other nodes in the partition. A dotted or broken line for a site indicates that the site has nodes that are part of the cluster but no nodes that are part of the replication tree. A replication disabled node is not available for serving as a target node for replication. A replication disabled node is identified with a “−” following the node identifier. The current cluster state includes the following information:

### CURRENT PARTITION: 1, 2, 3, 4, 5, 6, 7, 8, 9, 10, 12, 13, 14, 15, 16, 17

### ACTIVE NODES: 1, 7, 8, 9, 10, 12, 13

### REPLICATION DISABLED NODES: 10, 16

The process of generating a replication tree as set forth in FIG. 8 is illustrated with respect to the cluster partition of FIG. 10 in response to changes to the current cluster state.

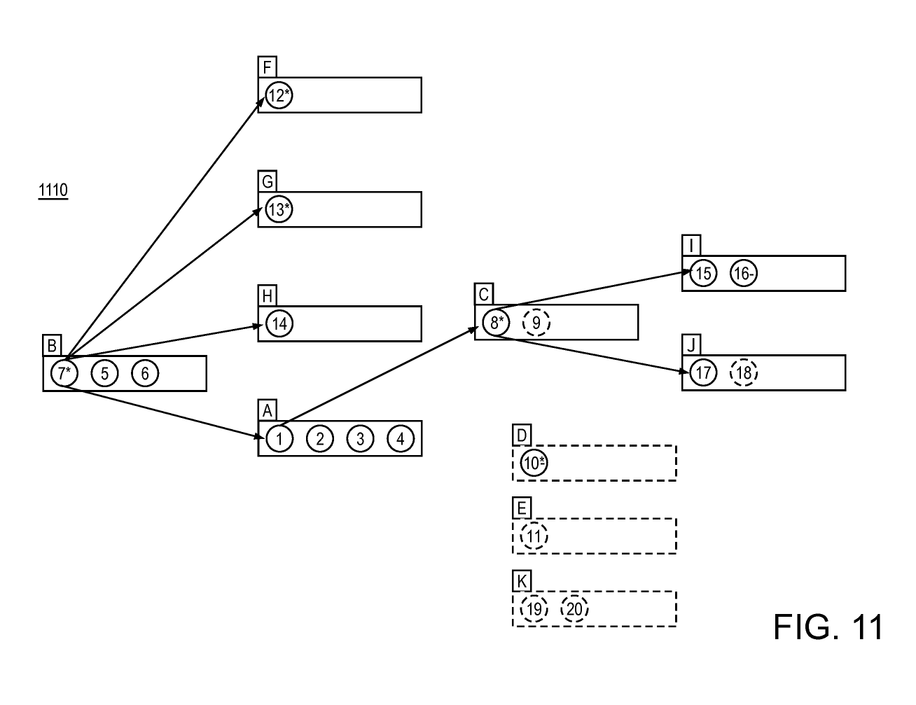

FIG. 11 illustrates the replication tree 1210 resulting from steps 820 to 840 where the cluster current state provided in step 810 is as illustrated in FIG. 10 and events have caused a number of changes. In this example the changes include changing node 1 from an active node to a passive node and removing node 9 from the partition because it is no longer visible on the network. The goal cluster node list provided by step 810 is as follows:

### GOAL PARTITION: 1, 2, 3, 4, 5, 6, 7, 8, 10, 12, 13, 14, 15, 16, 17

### GOAL ACTIVE NODES: 7, 8, 10, 12, 13

### REPLICATION DISABLED NODES: 10, 16

In step 820 node 7 is selected as the root node because it is the lead node on the highest ranked site with an active node on it. The initial lead nodes from the other sites include 1, 8, 12, 13, 14, 15, 17 (i.e., the remaining node site list). The replication tree 1110 reflects the results of steps 810-840. The replication tree only includes the lead node from each site at this point (i.e., the highest ranked active node or, if no actives, the highest ranked passive node)

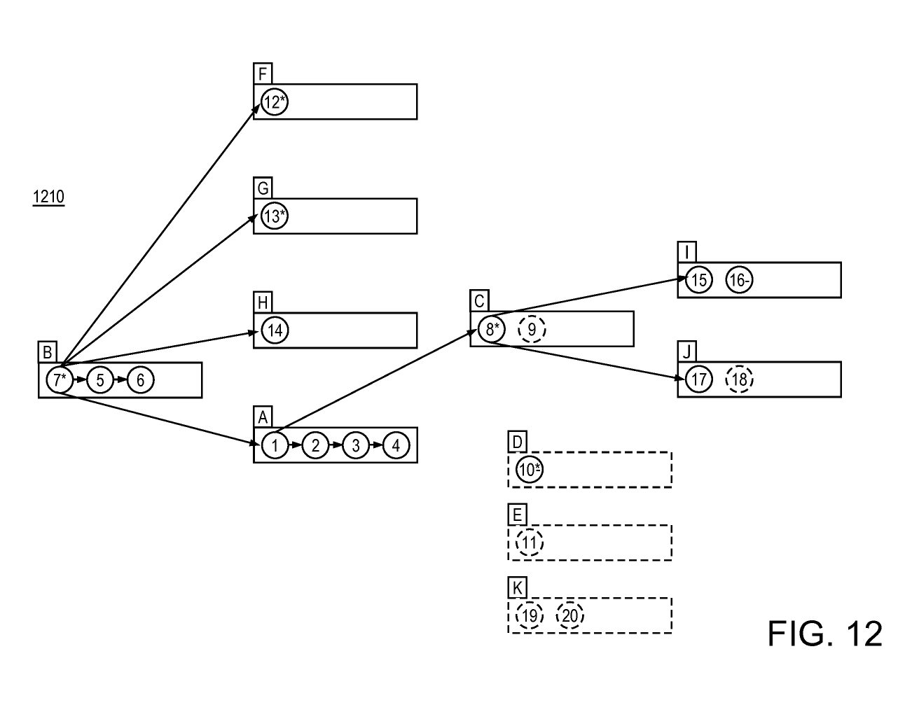

FIG. 12 illustrates the replication tree 1210 resulting from adding the remaining nodes at each site as described at step 850 of FIG. 8. In particular, the replication tree 1210 includes replication goal state nodes at each site. In one embodiment this is accomplished by extending a replication tree branch in daisy-chain fashion from the active node or dominant passive node to each of the other nodes in node id order at that site.

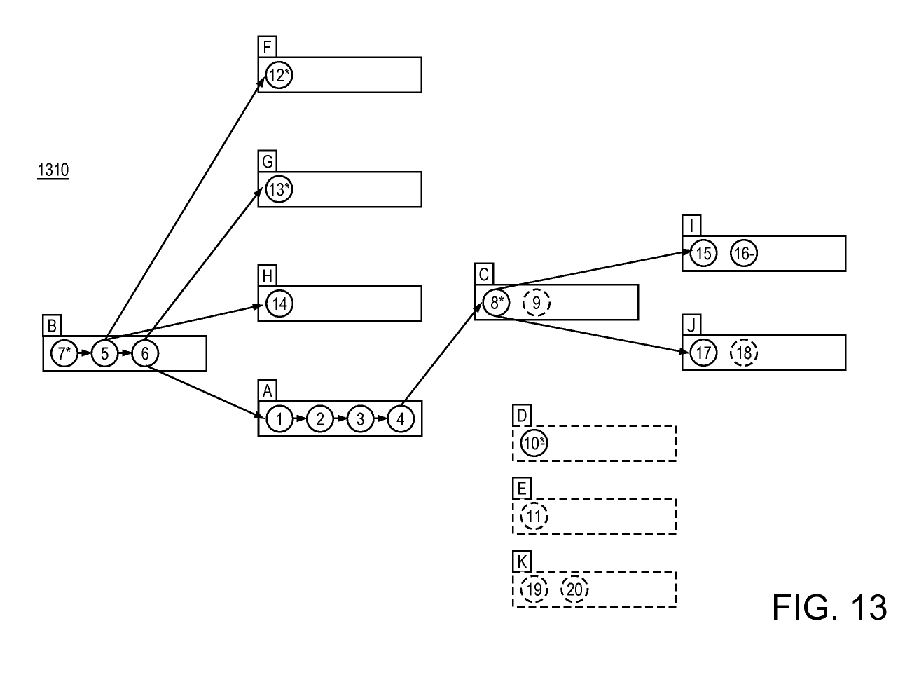

FIG. 13 illustrates the application of step 860 of FIG. 8 to the replication tree 1210 of FIG. 12. In particular, the nodes within a given site that are designated as source nodes are selected for load balancing in a round robin fashion. The result is a goal cluster state that includes the goal replication tree. The resulting goal cluster state 1310 is provided to the transition planner in list or table form.

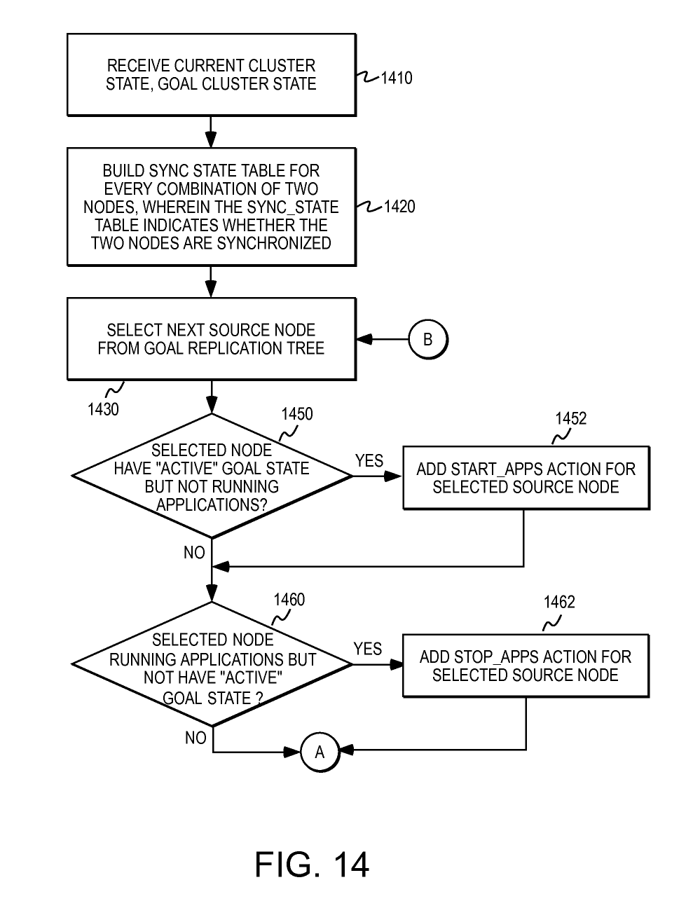

FIG. 14 illustrates one embodiment of a transition planner for generating a list of actions to transition from the current cluster state to the goal cluster state. The transition planner receives the current cluster state and the goal cluster state in step 1410.

In step 1420, a SYNC_STATE table is built. The SYNC_STATE table determines the current synchronization relationship between every pair of nodes in the current cluster. A pair of nodes is synchronized if both nodes have declared that they are directly synchronized with each other or if they are transitively synchronized. Two nodes X and Y are transitively synchronized if there is another node Z such that Z is synchronized with X and Z is synchronized with Y.

In one embodiment the current cluster state includes checkpoint information on the last group of updates applied by replication to one node of the cluster where the group of updates was first performed on a different node of the cluster. This checkpoint information allows any pair of nodes in a replication tree to continue to replicate and be synchronized, even if they are not a source and target node within the current replication tree. The mechanism, called “pending replication”, allows nodes in a cluster to remain synchronized while intermediary source and target nodes in the replication tree are synchronizing.

In step 1430, a source node of the goal replication tree is selected. Step 1450 determines whether the selected source node is designated as an “active” node in the goal cluster state but is not currently running applications. If so, then an action to start applications on the selected source node is added to the plan in step 1452.

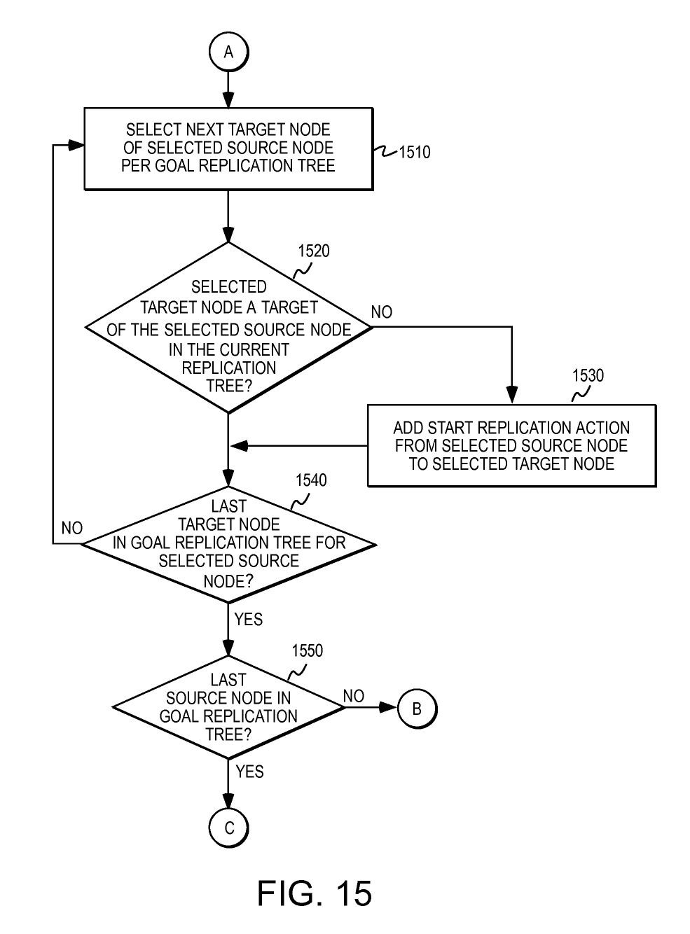

Step 1460 determines whether the selected source node is currently running applications but is not designated as “active” in the goal cluster state. An action to stop applications on the selected source node is added to the plan in step 1462. The planning process continues with FIG. 15.

Steps 1510-1540 establish an iterative process for creating actions to start replication for every node in the goal replication tree that is identified as a target node for the selected source node. Step 1510 selects the next target node of the selected source node per the goal replication tree. Step 1520 determines whether the selected target node is also designated as a target node for the selected source node in the current replication tree. If not, then an action to stop replication between the selected source node and the selected target node is added to the plan in step 1530.

Step 1540 determines whether the selected target node is the last target node (per the goal replication tree) for the selected source node. If not then the process continues with step 1510 to select another target node.

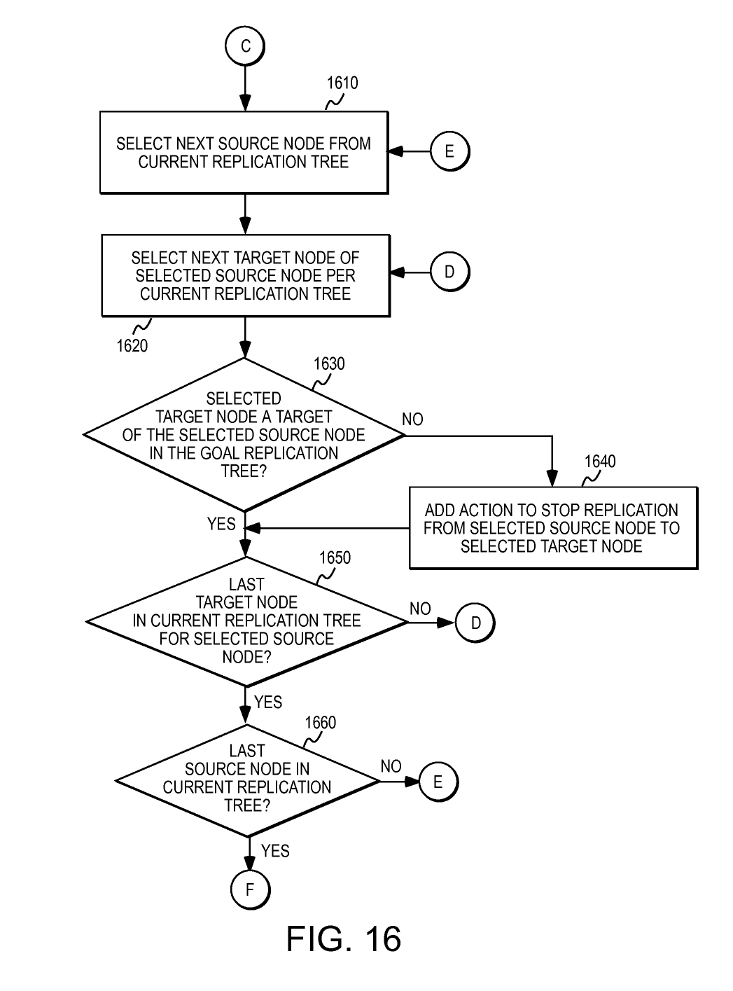

Once all the target nodes per the goal replication tree for the selected source node have been processed, step 1550 determines whether the selected source node is the last source node of the goal replication tree. If it is not, then processing continues with step 1430 to select another source node from the goal replication tree. Once all of the source nodes of the goal replication tree have been processed, transition planning continues with FIG. 16.

In step 1610, the next source node from the current replication tree is selected. The next target node of that selected source code (per the current replication tree) is selected in step 1620. Step 1630 determines whether the selected target node is a target node for the selected source node in the goal replication tree. If not, then an action to stop replication between the selected source node and the selected target node is added to the transition plan in step 1640.

Step 1650 determines whether there are any more target nodes for the selected source node per the current replication tree. If so, then processing continues with the next target node in step 1620.

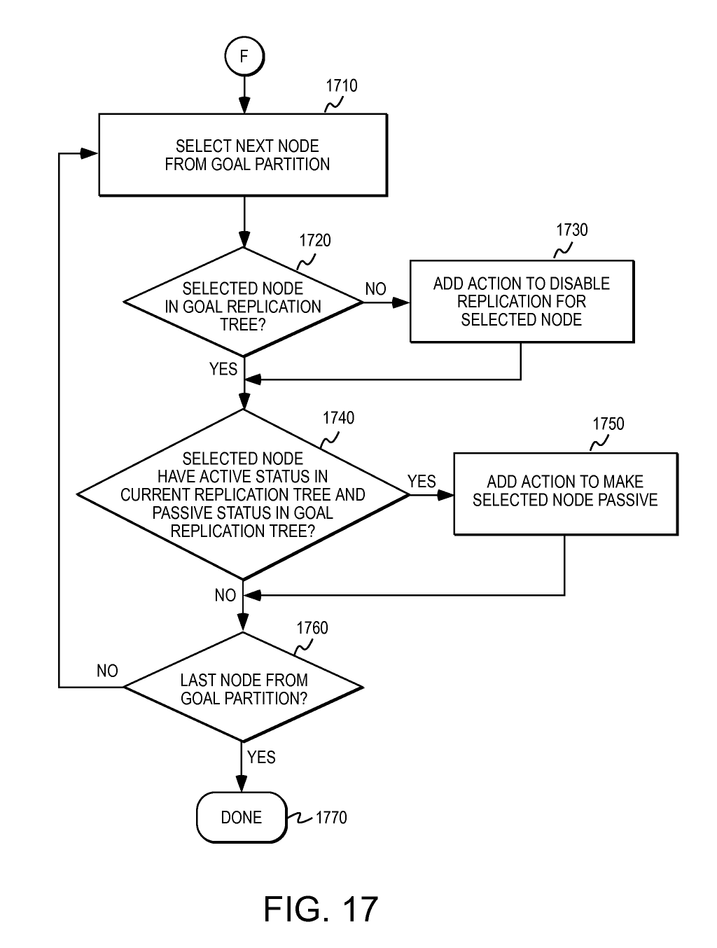

If there are no more target nodes for the selected source node per the current replication tree, then step 1660 determines whether there are any more source nodes to process per the current replication tree. If so, processing continues to step 1610 to select the next source node of the current replication tree. Otherwise processing continues with FIG. 17.

Steps 1710-1760 loop through all the nodes in the goal partition. In step 1710, a next node is selected from the goal partition. If the selected node is not in the goal replication tree as determined by step 1720, then an action to disable the selected node from replication is added to the plan in step 1730.

Step 1740 determines whether the selected node has an active status in the current replication tree and a passive status in the goal replication tree. If both conditions are true, then the state of the selected node is changed from active to passive in step 1750.

Step 1760 determines whether the selected node is the last node of the goal partition (i.e., whether all nodes in the goal partition have been processed). If not, then processing returns to step 1710 to select the next node from the goal partition. Otherwise the generation of the transition plan is completed and the process terminates in step 1770.

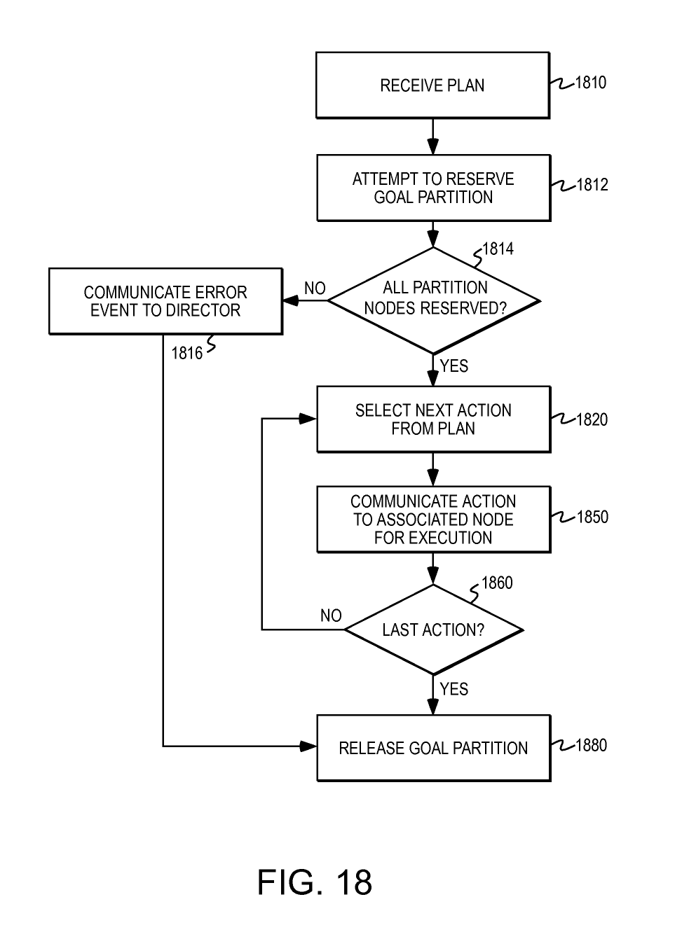

FIG. 18 illustrates one embodiment of a process for coordinating execution of the transition plan from a current cluster state to a goal cluster state. The transition plan having a list of actions is received in step 1810. In step 1812, an attempt is made to reserve the goal partition. Reservation prevents each node in the goal partition from acting upon or executing actions from any other plan except the current plan. If the reservation of all goal partition nodes is unsuccessful as determined by step 1814, then an error event is communicated to the director in step 1816 and any reservations are released in step 1880. One reason that a reservation may be unsuccessful, for example, is if a node is already reserved for execution of another transition plan.

If reservation is successful, then 1820 selects the next action from the plan as a selected action. The action is communicated to the designated node(s) in step 1850 for execution.

If the action is not the last action of the plan as determined by step 1860, then the process continues with step 1820 to select the next action from the plan. If, however, the selected action is the last action, then all partition nodes of the goal partition are released in step 1880.

The cluster management processes accommodate maintaining service level objectives during and after execution of the transition plan. Preservation of a record of the synchronization state enables the cluster management processes to avoid resource consuming resynchronization operations. For example, the current cluster state and the goal cluster state may have different nodes, however, maintenance of replication state information between nodes permits the cluster management processes to avoid re-synchronizing nodes remaining in the replication tree (i.e., in both trees) even though nodes may be added or removed when transitioning between cluster states.

The cluster management processes may accommodate scaling based on event frequency, node count, number of sites, potential number of cluster states, etc. For example, the cluster management is deemed to be “node scalable” when the cluster management meets the service level objectives independently of the number of nodes in the cluster or in the partition. The cluster management is considered to be “event scalable” when the service level objectives are met independently of the frequency of the events giving rise to a cluster state change. The cluster management is “site scalable” if the service level objects are met independently of the number of sites that the cluster nodes are distributed across. The cluster management is “state scalable” when the service level objectives are met independently of the number of possible cluster states.

The cost function used to identify the cluster goal state and replication tree may be selected to achieve a different metric or to make use of node functionality. For example, the metric may be chosen to reduce software utilization cost or hardware utilization cost by limiting the number of active nodes or the total number of nodes used for replication or for running services, for example. This is particularly useful when throughput demands are reduced as a result of a change in load. Thus the events giving rise to a cluster state change may also include, for example, utilization falling below below pre-determined levels. Such an event may trigger reductions in active nodes or total nodes, merging of services or applications to share the same node, or reducing the number of instances of an application running on the partition, etc. A virtual machine node, for example, may be readily configured to apply fewer virtual processors, reduce the speed of the processor, reduce the memory allocation for the applications, etc.

In one embodiment, the cluster management processes consider the time of day when determining a goal cluster state. In particular, the response time for the users will typically improve when nodes closer to the users are the active nodes running the applications they use. Accordingly, the choice of active node may be determined by site location and time of day.

Generally, in various embodiments, the cluster management processes may increase hardware utilization, software utilization, site utilization, etc. as necessary to meet service level objectives. The cluster management processes may reduce hardware utilization, software utilization, site utilization, etc. when possible so long as the service level objectives can continue to be met.

Methods and apparatus for maintaining a cluster to support applications in accordance with service level objectives have been described. In various embodiments the applications may include “continuous availability” applications.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A computer-implemented method for managing the state of a multi-node cluster, comprising:
a) receiving an event indicative of a possible change in a current cluster state;
b) identifying a goal cluster state if the current cluster state does not meet a service level objective, wherein the goal cluster state includes a replication tree for replication among the member nodes of the goal cluster state;
c) generating a transition plan for transitioning from the current cluster state to the goal cluster state; and
d) executing the transition plan to transition from the current cluster state to the goal cluster state.

2. The method of claim 1 wherein the service level objective is one of a recovery time objective and a recovery point objective.

3. The method of claim 1 wherein the service level objective is a response time for at least one operation performed by an application executing on a node.

4. The method of claim 3 wherein the at least one operation includes at least one of the operations of: saving a file, opening a file, forwarding an email message, and providing a web page.

5. The method of claim 1 wherein the cluster comprises at least three nodes.

6. The method of claim 5 wherein at least two of the nodes form a high availability set.

7. The method of claim 5 wherein at least one node forms a disaster recovery set for one or more of the remaining nodes, wherein the disaster recovery set is located at a distinct location from that of the one or more of the remaining nodes.

8. The method of claim 1 wherein one of the current cluster state and the goal cluster state includes both a high availability node set and a disaster recovery node set, wherein the disaster recovery node set is located at a distinct physical location from that of the high availability node set.

9. The method of claim 1 wherein the cluster comprises a plurality of nodes, wherein the nodes are distributed across a plurality of distinct locations, wherein the plurality of nodes are communicatively coupled to each other.

10. The method of claim 9 wherein there is at least one communicative coupling between nodes that is topologicially distinct from another communicative coupling between nodes.

11. The method of claim 1 wherein one of the current cluster state and the goal cluster state includes a plurality of active nodes.

12. The method of claim 1 wherein at least one node is a virtual node.

13. The method of claim 1 wherein at least one node is a physical node.

14. The method of claim 1 wherein at least one node is a physical node and at least one node is a virtual node.

15. The method of claim 1 wherein the event is a failure of one of hardware or software on a node of the cluster.

16. The method of claim 1 where the event triggering a state change is the failure of the hardware or software on a node of the cluster.

17. The method of claim 1 where the event triggering a state change is loss of connection between one subset of nodes in a cluster and a different subset of nodes in the cluster.

18. The method of claim 1 where the event triggering a possible state change is a failure to meet a service level objective.

19. The method of claim 1 where the event triggering a state change is a command from a user interface to stop or start: nodes, applications or application services.

20. The method of claim 1 where the event triggering a state change is a command from a user interface to change the state of active or passive nodes in the cluster.
